(19) United States
(12) Patent Application Publication
(10) Pub. No.: US 2007/0194837 A1
(43) Pub. Date: Aug. 23, 2007

(54) OLED PANEL AND RELATED CURRENT MIRRORS FOR DRIVING THE SAME

(76) Inventors: Yu-Wen Chiou, Tainan County (TW); Lin-Kai BU, Tai-Nan County (TW)

Correspondence Address: NORTH AMERICA INTELLECTUAL PROPERTY CORPORATION, P.O. BOX 506, MERRIFIELD, VA, 22116, US

(21) Appl. No.: 11/382,486

(22) Filed: May 10, 2006

(30) Foreign Application Priority Data
Feb. 17, 2006 (TW) 095105538

(51) Int. Cl. G05F 1/10

(52) U.S. Cl. 327/543

(57) ABSTRACT

A current mirror for driving an OLED panel is provided. The current mirror of the present invention adopts low voltage MOS transistors as the primary part of the current mirror so as to provide currents with high uniformity. The present invention also utilizes high voltage devices to bias the current mirror, such that the high voltage used for the OLED panel could serve for the claimed current mirror. The performance of the OLED panel is improved due to the uniformity of currents provided by the current mirror of the present invention.

### BACKGROUND OF THE INVENTION

1. Field of the Invention

The present invention relates to an OLED panel and the related current mirrors for driving the same, and more particularly, to an OLED panel and the related current mirrors capable of providing stable driving currents for driving the OLED panel.

2. Description of the Prior Art

With rapid development of technology, light and portable electronic devices with low power consumption are widely used in everyday life. Among these electronic devices such as cellular phones, personal digital assistants (PDAs) or notebook computers, displays are required as interaction interfaces between users and machines. Recently, flat panel display (FPD) devices have been developed for providing high-resolution images, large screen size and reduced costs. Among various FPD devices, organic light-emitting diode (OLED) panels have gradually gained more and more attention in mid/small-sized applications due to advantages such as self-emitting light sources, wide viewing angles, fast response time, low power consumption, high contrast, high brightness, full color, simple structure, and a large range of operational temperatures. With manufacturing problems such as low yield, improper mask applications or unstable cap sealing processes being solved in recent years, OLED panels have become the future trends.

An OLED panel is a current-driven device whose luminance is determined by its passing current. Therefore the stability of the driven current is very important. For a panel using high-resolution passive matrix OLEDs (PMOLEDs) or current-mode active matrix OLEDs (AMOLEDs), the uniformity between current provided to different pixels of the OLED panel is crucial for providing quality images.

A PMOLED panel can be driven by means of pulse width modulation (PWM) in which the duty cycles of pulse voltages are changed for controlling the luminance of the PMOLED. Conventionally, a current mirror is used for driving an OLED panel. Since high voltage sources are required, the current mirror includes high voltage metal oxide semiconductor (HV MOS) transistors. Reference is made to FIG. 1 showing a prior art current mirror 100 for driving an OLED panel by means of PWM. The current mirror 100 includes n+1 high voltage p-type metal oxide semiconductor (HV PMOS) transistors P0-Pn (only P0, P1, P2 and Pn are depicted in FIG. 1). The current mirror 100 receives a high voltage Vcc_HV. As shown in FIG. 1, the source and base terminals of each HV PMOS transistor are coupled to the high voltage source Vcc_HV. The current mirror 100 outputs currents I1-In to an OLED panel at the drain terminals of the HV PMOS transistors P0-Pn. However, the threshold voltages of the HV PMOS transistors P0-Pn can deviate from the nominal value differently, resulting in large variations between the currents I1-In. Therefore, the prior art current mirror 100 cannot provide the OLED panel with stable driving currents required for achieving high-resolution images.

Reference is made to FIG. 2 showing another prior art current mirror 200 for driving an OLED panel by means of PWM. Compared to the prior art current mirror 100, the prior art current mirror 200 has a cascode structure and further includes n+1 HV PMOS transistors PC0-PCn (only PC0, PC1, PC2 and PCn are depicted in FIG. 2) coupled in series with the corresponding HV PMOS transistors P0-Pn. Since the transistors P0-Pn are HV PMOS transistors, voltages established at the drain terminals (nodes A0-An in FIG. 2) can be very high. For safety reasons, all devices used in the prior art current mirror 200 have to be HV PMOS transistors. Therefore, the threshold voltages of the HV PMOS transistors P0-Pn and PC0-PCn can still deviate from the nominal value differently, resulting in large variations between the currents I1-In. Therefore, the prior art current mirror 200 cannot provide the OLED panel with stable driving currents required for achieving high-resolution images.

A PMOLED panel can also be driven by means of pulse amplitude modulation (PAM). Reference is made to FIG. 3 showing an M-bit PAM module 30. The PAM module 30 includes switches SW1-SWm and NMOS transistors N1-Nm. I_{DC1}-I_{DCm} represent currents passing through the NMOS transistors N1-Nm, respectively. The PAM module 30 controls passages of the current I_{DC1}-I_{DCm} using the switches SW1-SWn, thereby controlling the amount of the total current I_{DC}.

Reference is made to FIG. 4 showing a prior art current mirror 400 for driving an OLED panel by means of PAM. The current mirror 400 includes a current source I_{DC}, an n-type metal oxide semiconductor (NMOS) transistor N0, 2n HV PMOS transistors P1-Pn and P1′-Pn′, and PAM modules PAM1-PAMn. The current mirror 300 receives a high voltage Vcc_HV. As shown in FIG. 3, the source and base terminals of each HV PMOS transistor is coupled to the high voltage Vcc_HV, and the drain terminals the HV PMOS transistors P1′-Pn′ are coupled to the PAM modules PAM1-PAMn, respectively. The PAM modules PAM1-PAMn can each include the M-bit PAM module 30 shown in FIG. 3. The drain currents I1′-In′ of the HV PMOS transistors P1′-Pn′ are outputted to an OLED panel. The PAM modules PAM1-PAMn control the amount of the drain currents I1-In passing through the HV PMOS transistors P1-Pn, thereby controlling the amount of the drain currents I1′-In′ passing through the HV PMOS transistors P1′-Pn′. The threshold voltages of the HV PMOS transistors P1-Pn and P1′-Pn′ can deviate from the nominal value differently, resulting in large variations between the currents I1′-In′. Therefore, the current mirror 400 cannot provide the OLED panel with stable driving currents required for achieving high-resolution images.

Reference is made to FIG. 5 showing another prior art current mirror 500 for driving an OLED panel by means of PAM. Compared to the prior art current mirror 400, the prior art current mirror 500 has a cascode structure and further includes 2n HV PMOS transistors PC1-PCn and PC1′-PCn′ coupled in series with the corresponding HV PMOS transistors P1-Pn and P1′-Pn′, respectively. Since transistors P1-Pn and P1′-Pn′ are HV PMOS transistors, voltages established at the drain terminals (nodes A1-An in FIG. 5) can be very high. For safety reasons, all devices used in the prior art current mirror 500 have to be HV PMOS transistors. Therefore, the threshold voltages of the HV PMOS transistors P1-Pn and P1′-Pn′ can still deviate from the nominal value differently, resulting in large variations between the currents I1′-In′ outputted to the OLED panel. Therefore, the current mirror 500 cannot provide the OLED panel with stable driving currents required for achieving high-resolution images.

Reference is made to FIG. 6 showing another prior art current mirror 600 for driving an OLED panel by means of PAM. Compared to the prior art current mirror 500, the prior art current mirror 600 also has a cascode structure, but the drain terminals of the HV PMOS transistors PC1-PCn are respectively coupled to the gate terminals of the HV PMOS transistors P1-Pn, and the base terminals of the HV PMOS transistors PC1-PCn and PC1′-PCn′ are coupled to a reference voltage. In the current mirror 600, the threshold voltages of the HV PMOS transistors P1-Pn and P1′-Pn′ can deviate from the nominal value differently, resulting in large variations between the currents I1′-In′ outputted to the OLED panel. Therefore, the current mirror 600 cannot provide the OLED panel with stable driving currents required for achieving high-resolution images.

In an AMOLED panel, each OLED pixel is controlled by a thin film transistor (TFT) switch. The data driver for driving the AMOLED panel includes a digital-to-analog converter (DAC) capable of generating driving currents corresponding to image data. Depending on current directions, data drivers can be categorized into two types: sink-mode data drivers and source-mode data drivers. Reference is made to FIG. 7 showing a prior art sink-mode current mirror 700 for driving an AMOLED panel. The current mirror 700 includes a current source I_{DC}, n HV NMOS transistors N0-Nn, and switches SW1-SWn. The drain terminal of the HV NMOS transistor N0 is coupled to current source I_{DC}, and the drain terminals of the HV NMOS transistors N1-Nn are coupled to the AMOLED panel via the switches SW1-SWn, respectively. Therefore, the current mirror 700 controls the amount of the driving current I by turning on/off the switches SW1-SWn. However, the threshold voltages of the HV NMOS transistors N1-Nn can still deviate from the nominal value differently, resulting in large variations between the currents passing through each HV NMOS transistor. Therefore, the current mirror 700 cannot provide the AMOLED panel with stable driving currents required for achieving high-resolution images.

Reference is made to FIG. 8 showing a prior art source-mode current mirror 800 for driving an AMOLED panel. The current mirror 800 includes a current source I_{DC}, n HV PMOS transistors P0-Pn, and switches SW1-SWn. The drain terminal of the HV PMOS transistor P0 is coupled to current source I_{DC}, and the drain terminals of the HV PMOS transistors P1-Pn are coupled to the AMOLED panel via the switches SW1-SWn, respectively. Therefore, the current mirror 800 controls the amount of the driving current I by turning on/off the switches SW1-SWn. However, the threshold voltages of the HV PMOS transistors P0-Pn can still deviate from the nominal value differently, resulting in large variations between the currents passing through each HV PMOS transistor. Therefore, the current mirror 800 cannot provide the AMOLED panel with stable driving currents required for achieving high-resolution images.

### SUMMARY OF THE INVENTION

The present invention provides a current mirror for driving an organic light-emitting diode panel comprising: a first low voltage P-type metal oxide semiconductor (LV PMOS) transistor comprising a source terminal coupled to a first reference voltage, a drain terminal, and a gate terminal coupled to the drain terminal of the first LV PMOS transistor; a second LV PMOS transistor comprising a source terminal coupled to the first reference voltage; a drain terminal, and a gate terminal coupled to the gate terminal of the first LV PMOS transistor; a first high voltage (HV) device coupled between the drain terminal of the first LV PMOS transistor and a first current source for biasing the first LV PMOS transistors to operate at a predetermined low voltage; and a second HV device coupled to the drain of the second LV PMOS transistor and an OLED panel for biasing the second LV PMOS transistors to operate at the predetermined low voltage.

The present invention further provides an OLED display comprising an OLED panel and a current mirror for driving the OLED panel. The current mirror includes a first LV PMOS transistor comprising a source terminal coupled to a first reference voltage, a drain terminal, and a gate terminal coupled to the drain terminal of the first LV PMOS transistor; a second LV PMOS transistor comprising a source terminal coupled to the first reference voltage, a drain terminal, and a gate terminal coupled to the gate terminal of the first LV PMOS transistor; a first HV device coupled between the drain terminal of the first LV PMOS transistor and a first current source for biasing the first LV PMOS transistor to operate at a predetermined low voltage; and a second HV device coupled between the drain terminal of the second LV PMOS transistor and the OLED panel for biasing the second LV PMOS transistor to operate at the predetermined low voltage.

The present invention further provides a current mirror for driving a PMOLED panel comprising a current source; a first LV PMOS transistor comprising a source terminal coupled to a first reference voltage, a drain terminal, and a gate terminal coupled to the drain terminal of the first LV PMOS transistor; a second LV PMOS transistor comprising a source terminal coupled to the first reference voltage, a drain terminal, and a gate terminal coupled to the drain terminal of the first LV PMOS transistor; a first HV device coupled to the drain terminal of the first LV PMOS transistor for biasing the first LV PMOS transistor to operate at a predetermined low voltage; a second HV device coupled to the drain terminal of the second LV PMOS transistor and the PMOLED panel for biasing the second LV PMOS transistor to operate at the predetermined low voltage; a pulse amplitude modulation module coupled to the first HV device for controlling the current passing through the first LV PMOS transistor; and an N-type metal oxide semiconductor transistor comprising a source terminal coupled to the current source, a drain terminal, and a gate coupled to the PAM module for enabling the PAM module.

The present invention further provides a PMOLED display comprising a PMOLED panel and a current source for driving the PMOLED panel. The current source includes a first LV PMOS transistor comprising a source terminal coupled to a first reference voltage, a drain terminal, and a gate terminal coupled to the drain terminal of the first LV PMOS transistor; a second LV PMOS transistor comprising a source terminal coupled to the first reference voltage, a drain terminal, and a gate terminal coupled to the drain terminal of the first LV PMOS transistor; a first HV device coupled to the drain terminal of the first LV PMOS transistor for biasing the first LV PMOS transistor to operate at a predetermined low voltage; a second HV device coupled to the drain terminal of the second LV PMOS transistor and the PMOLED panel for biasing the second LV PMOS transistor to operate at the predetermined low voltage; a PAM module coupled to the first HV device for controlling the current passing through the first LV PMOS transistor; and an NMOS transistor comprising a source terminal coupled to the current source, a drain terminal, and a gate terminal coupled to the PAM module for enabling the PAM module.

The present invention further provides a current mirror for driving an AMOLED panel comprising a current source; a first LVNMOS transistor comprising a source terminal, a drain terminal, and a gate terminal coupled to the drain terminal of the first LVNMOS transistor; a second LVNMOS transistor comprising a source terminal coupled to the source terminal of the first LVNMOS transistor, a drain terminal, and a gate terminal coupled to the gate terminal of the first LVNMOS transistor; a first HV device coupled between the drain terminal of the first LVNMOS transistor and the current source for biasing the first LVNMOS transistor to operate at a predetermined low voltage; a second HV device coupled to the drain terminal of the second LVNMOS transistor for biasing the second LV NMOS transistor to operate at the predetermined low voltage; and a switch coupled between the second HV device and the AMOLED panel.

The present invention further provides an AMOLED display device comprising an AMOLED panel and a current source for driving the AMOLED panel. The current source includes a first LVNMOS transistor comprising a source terminal, a drain terminal, and a gate terminal coupled to the drain terminal of the first LVNMOS transistor; a second LVNMOS transistor comprising a source terminal coupled to the source terminal of the first LVNMOS transistor, a drain terminal, and a gate terminal coupled to the gate terminal of the first LVNMOS transistor; a first HV device coupled between the drain terminal of the first LVNMOS transistor and the current source for biasing the first LVNMOS transistor to operate at a predetermined low voltage; a second HV device coupled to the drain terminal of the second LVNMOS transistor for biasing the second LVNMOS transistor to operate at the predetermined low voltage; and a switch coupled between the second HV device and the AMOLED panel.

The present invention further provides a current mirror for driving an AMOLED panel comprising a current source; a first LV PMOS transistor comprising a source terminal, a drain terminal, and a gate terminal coupled to the drain terminal of the first LV PMOS transistor; a second LV PMOS transistor comprising a source terminal coupled to the source terminal of the first LV PMOS transistor, a drain terminal, and a gate terminal coupled to the gate terminal of the first LV PMOS transistor; a first HV device coupled between the drain terminal of the first LVNMOS transistor and the current source for biasing the first LV PMOS transistor to operate at a predetermined low voltage; a second HV device coupled to the drain of the second LVNMOS transistor for biasing the second LV PMOS transistor to operate at the predetermined low voltage; and a switch coupled between the second HV device and the AMOLED panel.

The present invention further provides an AMOLED display device comprising an AMOLED panel and a current source for driving the AMOLED panel. The current mirror includes a first LV PMOS transistor comprising a source terminal, a drain terminal, and a gate terminal coupled to the drain terminal of the first LV PMOS transistor; a second LV PMOS transistor comprising a source terminal coupled to the source terminal of the first LV PMOS transistor, a drain terminal, and a gate terminal coupled to the gate terminal of the first LV PMOS transistor; a first HV device coupled between the drain terminal of the first LV PMOS transistor and the current source for biasing the first LV PMOS transistor to operate at a predetermined low voltage; a second HV device coupled to the drain terminal of the second LV PMOS transistor for biasing the second LV PMOS transistor to operate at the predetermined low voltage; and a switch coupled between the second HV device and the AMOLED panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art current mirror for driving an OLED panel by means of PWM.

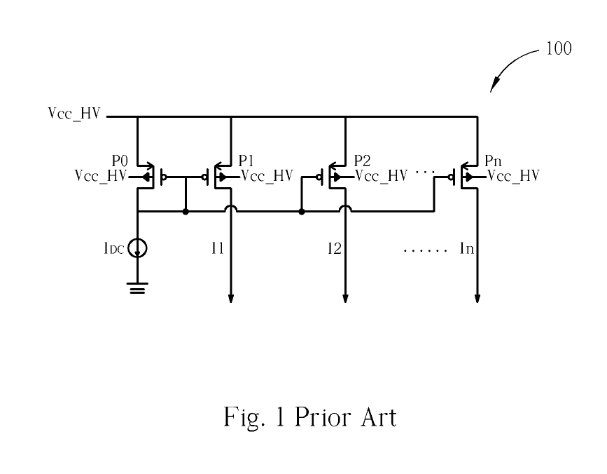

FIG. 2 shows another prior art current mirror for driving an OLED panel by means of PWM.

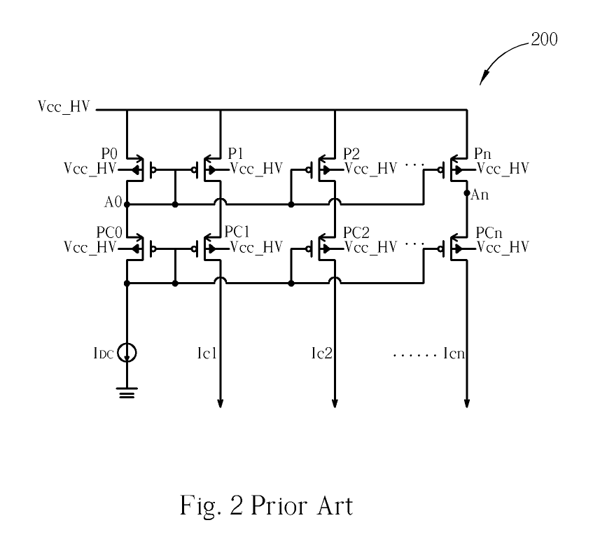

FIG. 3 shows an M-bit PAM module.

FIG. 4 shows a prior art current mirror for driving an OLED panel by means of PAM.

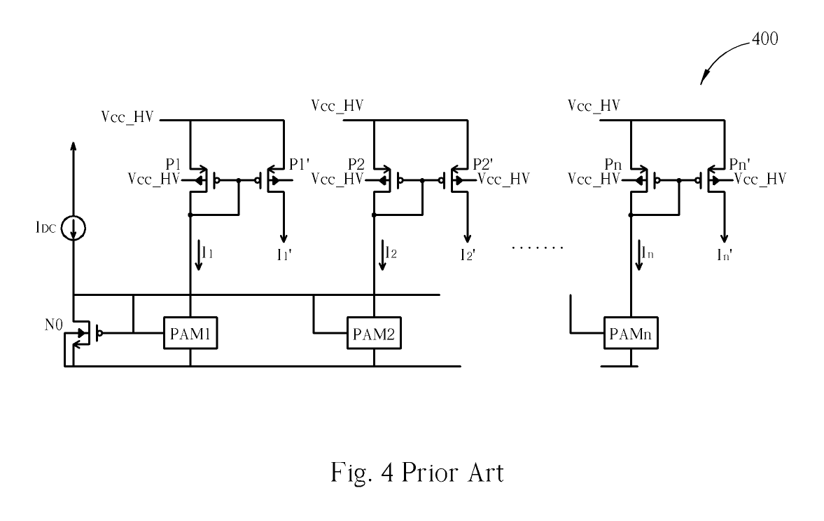

FIG. 5 shows another prior art current mirror for driving an OLED panel by means of PAM.

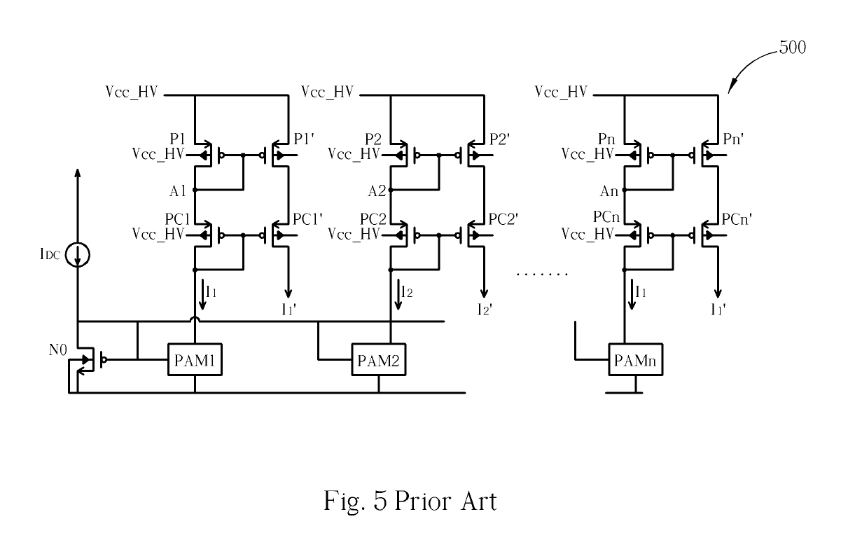

FIG. 6 shows another prior art current mirror for driving an OLED panel by means of PAM.

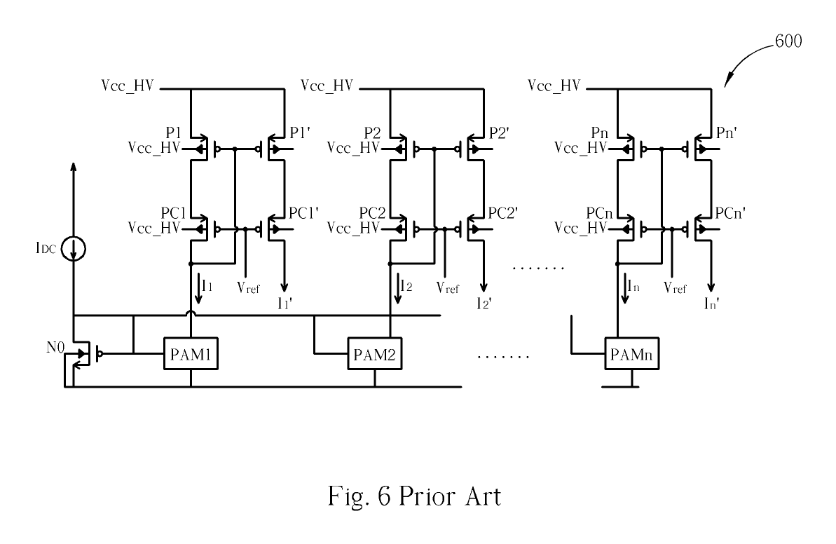

FIG. 7 shows a prior art sink-mode current mirror for driving an AMOLED panel.

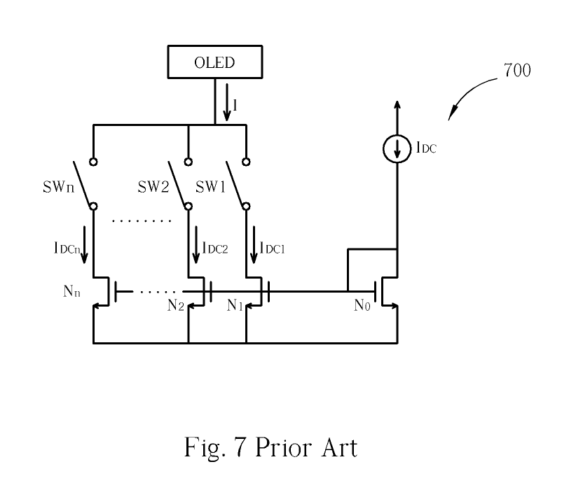

FIG. 8 shows a prior art source-mode current mirror for driving an AMOLED panel.

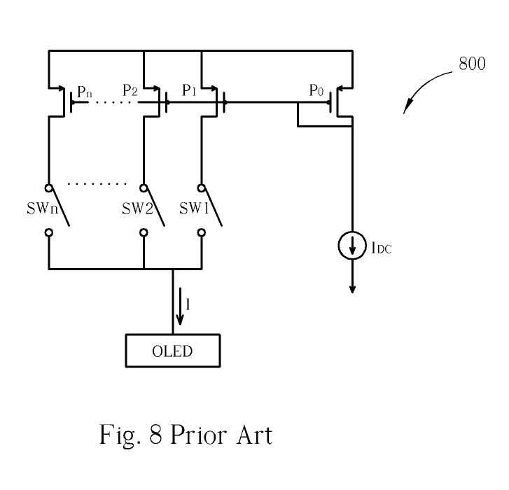

FIG. 9 shows a current mirror for driving a PMOLED panel by means of PWM according to the present invention.

FIG. 10 shows a current mirror for driving a PMOLED panel according to a first embodiment of the present invention.

FIG. 11 shows a current mirror for driving a PMOLED panel according to a second embodiment of the present invention.

FIG. 12 shows a current mirror for driving a PMOLED panel according to a third embodiment of the present invention.

FIG. 13 shows a current mirror for driving a PMOLED panel according to a fourth embodiment of the present invention.

FIG. 14 shows a current mirror for driving a PMOLED panel by means of PAM according to the present invention.

FIG. 15 shows a current mirror for driving a PMOLED panel according to a fifth embodiment of the present invention.

FIG. 16 shows a current mirror for driving a PMOLED panel according to a sixth embodiment of the present invention.

FIG. 17 shows a current mirror for driving a PMOLED panel according to a seventh embodiment of the present invention.

FIG. 18 shows a current mirror for driving a PMOLED panel according to an eighth embodiment of the present invention.

FIG. 19 shows a sink-mode current mirror for driving an AMOLED panel according to the present invention.

FIG. 20 shows a source-mode current mirror for driving an AMOLED panel according to the present invention.

FIG. 21 shows a sink-mode current mirror for driving an AMOLED panel according to a ninth embodiment of the present invention.

FIG. 22 shows a sink-mode current mirror for driving an AMOLED panel according to a tenth embodiment of the present invention.

FIG. 23 shows a sink-mode current mirror for driving an AMOLED panel according to an eleventh embodiment of the present invention.

FIG. 24 shows a sink-mode current mirror for driving an AMOLED panel according to a twelfth embodiment of the present invention.

FIG. 25 shows a source-mode current mirror for driving an AMOLED panel according to a thirteenth embodiment of the present invention.

FIG. 26 shows a source-mode current mirror for driving an AMOLED panel according to a fourteenth embodiment of the present invention.

FIG. 27 shows a source-mode current mirror for driving an AMOLED panel according to a fifteenth embodiment of the present invention.

FIG. 28 shows a source-mode current mirror for driving an AMOLED panel according to a sixteenth embodiment of the present invention.

### DETAILED DESCRIPTION

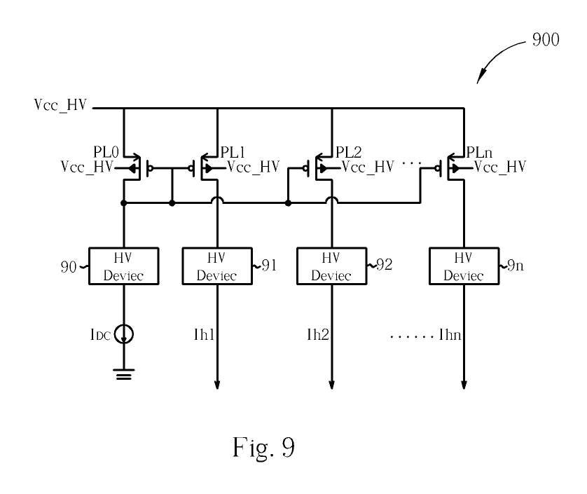

Reference is made to FIG. 9 showing a current mirror 900 for driving a PMOLED panel by means of PWM according to the present invention. Unlike the prior art current mirrors, the current mirror 900 includes n+1 low voltage p-type metal oxide semiconductor (LV PMOS) transistors PL0-PLn (only PL0, PL1, PL2 and PLn are depicted in FIG. 9) and HV devices 90-9n respectively coupled in series with the LV PMOS transistors PL0-PLn. The HV devices 90-9n provide bias voltages for the LV PMOS transistors PL0-PLn. As shown in FIG. 9, the current mirror 900 also receives a high voltage Vcc_HV. In other words, the source and base terminals of each LV PMOS transistor are coupled to the high voltage Vcc_HV. Since the threshold voltage of an LV PMOS transistor is more stable than that of a HV PMOS transistor, the current mirror 900 can provide stable driving currents Ih1-Ihn to the PMOLED panel for achieving high-resolution images. The sizes (W/L ratios) of the LV PMOS transistors PL0-PLn can be determined based on their operating voltage limits, and appropriate bias voltages can be provided at the drain terminals of the LV PMOS transistors PL0-PLn using the HV devices 90-9n. Therefore, although the current mirror 900 receives the high voltage Vcc_HV, it can still provide stable driving currents Ih1-Ihn to the PMOLED panel for achieving high-resolution images.

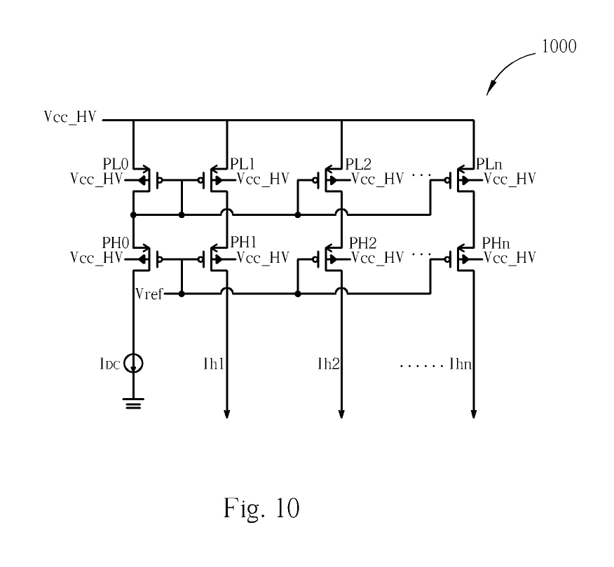

Reference is made to FIG. 10 showing a current mirror 1000 for driving a PMOLED panel according to a first embodiment of the present invention based on the structure of the current mirror 900. As shown in FIG. 10, the current mirror 1000 has a cascode structure and includes n+1 HV PMOS transistors PH0-PHn (only PH0, PH1, PH2 and PHn are depicted in FIG. 10) for respectively biasing the LV PMOS transistors PL0-PLn. The gate terminals of the HV PMOS transistors PH0-PHn are coupled to a reference voltage Vref, and the source terminals of the HV PMOS transistors PH0-PHn are respectively coupled to the drain terminals of the LV PMOS transistors PL0-PLn.

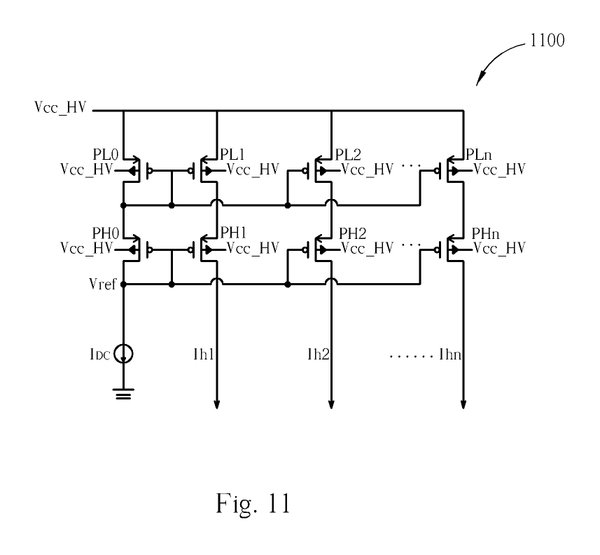

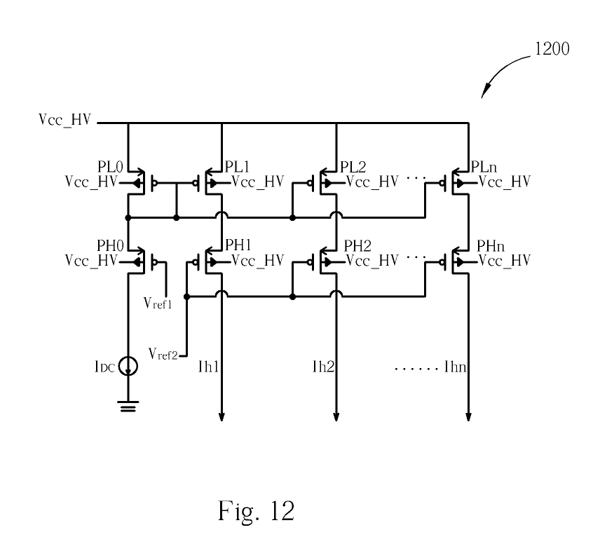

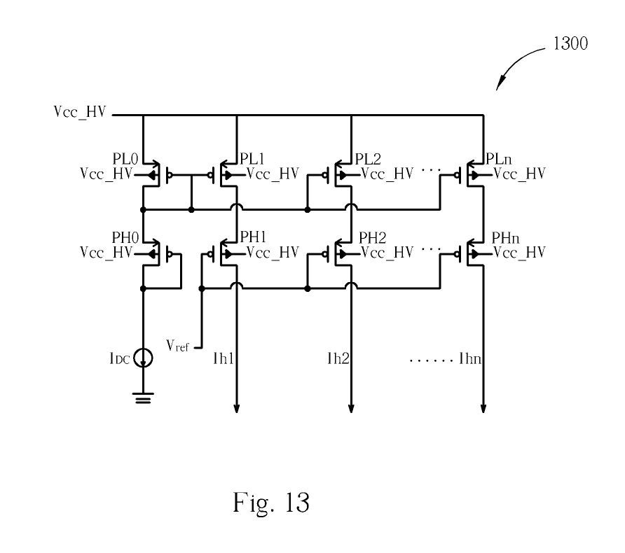

References are made to FIGS. 11-13 showing current mirrors 1100-1300 according to a second, third and fourth embodiments of the present invention based on the structure of the current mirror 900. Similar to the current mirror 1000, the HV PMOS transistors PH0-PHn are used for the HV devices 90-9n in the current mirrors 1100-1300. However, the gate terminals of the HV PMOS transistors PH0-PHn are coupled differently in the current mirrors 1100-1300. In the current mirror 1100 shown in FIG. 11, the gate terminals of the HV PMOS transistors PH0-PHn are coupled to the drain terminal of the HV PMOS transistor PH0. In the current mirror 1200 shown in FIG. 12, the gate terminal of the HV PMOS transistor PH0 is coupled to a first reference voltage Vref1, and the gate terminals of the HV PMOS transistors PH1-PHn are coupled to a second reference voltage Vref2. In the current mirror 1300 shown in FIG. 13, the gate terminal and the drain terminal of the HV PMOS transistor PH0 are coupled together, and the gate terminals of the HV PMOS transistors PH1-PHn are coupled to a reference voltage Vref. Various circuits commonly known to those skilled in the art can be used for generating the reference voltages Vref, Vref1, and Vref2.

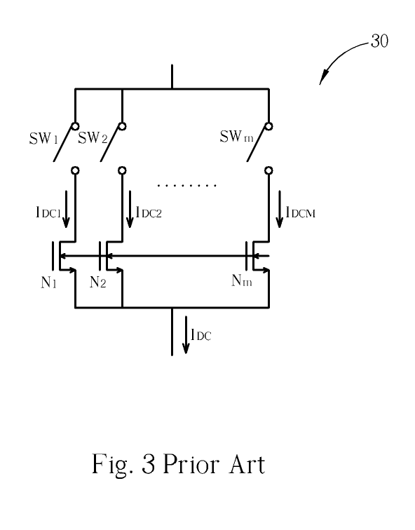

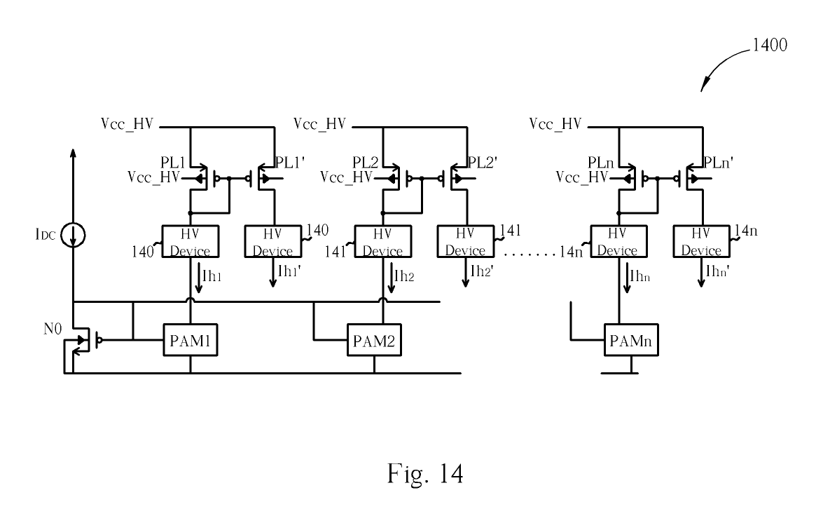

Reference is made to FIG. 14 showing a current mirror 1400 for driving a PMOLED panel by means of PAM according to the present invention. Unlike the prior art current mirror 400, the current mirror 1400 includes 2n LV PMOS transistors PL0-PLn and PL0′-PLn′, together with HV devices 140-14n respectively coupled in series with the LV PMOS transistors PL0-PLn and PL0′-PLn′. The HV devices 140-14n provide bias voltages for the LV PMOS transistors PL0-PLn and PL0′-PLn′. As shown in FIG. 14, the current mirror 1400 also receives a high voltage Vcc_HV. In other words, the source and base terminals of each LV PMOS transistor are coupled to the high voltage Vcc_HV, and the drain terminals of the LV PMOS transistor PL1-PLn are coupled to PAM modules PAM1-PAMn via the HV devices 140-14n, respectively. The PAM modules PAM1-PAMn can each include the M-bit PAM module 30 shown in FIG. 3. The HV devices 140-14n coupled to the LV PMOS transistors PL0-PLn output currents Ih1-Ihn, while the HV devices 140-14n coupled to the LV PMOS transistors PL0′-PLn′ output currents Ih1′-Ihn′ to the PMOLED panel. The PAM modules PAM1-PAMn control the amount of the drain currents Ih1-Ihn passing through the LV PMOS transistors PL1-PLn, thereby controlling the amount of the drain currents Ih1′-Ihn′ passing through the LV PMOS transistors PL1′-LPn′. Since the threshold voltage of an LV PMOS transistor is more stable than that of a HV PMOS transistor, the current mirror 1400 can provide stable driving currents Ih1′-Ihn′ to the PMOLED panel for achieving high-resolution images. The size (W/L ratio) of each LV PMOS transistor can be determined based on its operating voltage limit, and appropriate bias voltages can be provided at the drain terminals of the LV PMOS transistors PL0-PLn and PL0′-PLn′ using the HV devices 140-14n. Therefore, although the current mirror 1400 receives the high voltage Vcc_HV, it can still provide stable driving currents Ih1′-Ihn′ to the PMOLED panel for achieving high-resolution images.

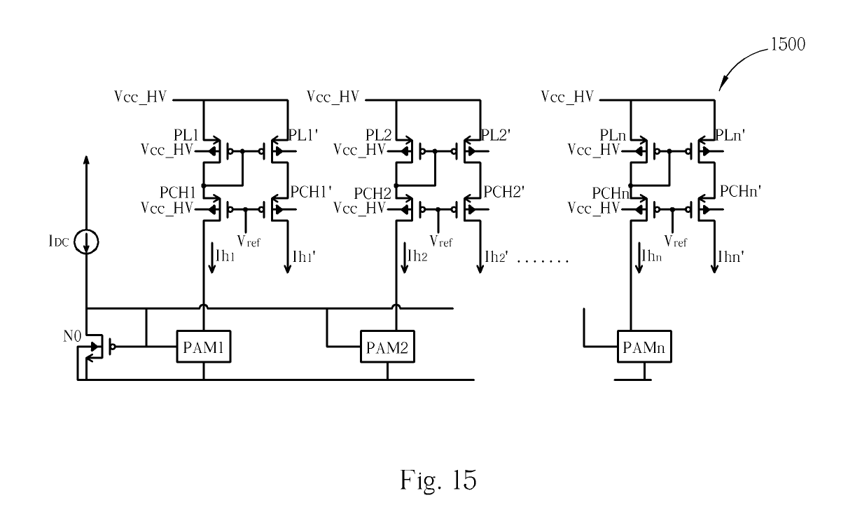

Reference is made to FIG. 15 showing a current mirror 1500 for driving a PMOLED panel according to a fifth embodiment of the present invention based on the structure of the current mirror 1400. As shown in FIG. 15, the current mirror 1500 includes 2n HV PMOS transistors PCH1-PCHn and PCH1′-PCHn′ for respectively biasing the LV PMOS transistors PL0-PLn and PL1′-PLn′. The gate terminals of the HV PMOS transistors PCH1-PCHn and PCH1′-PCHn′ are coupled to a reference voltage Vref, and the source terminals of the HV PMOS transistors PCH1-PCHn and PCH1′-PCHn′ are respectively coupled to the drain terminals of the LV PMOS transistors PL0-PLn and PL0′-PLn′. Since the threshold voltage of an LV PMOS transistor is more stable than that of a HV PMOS transistor, the current mirror 1500 can provide stable driving currents Ih1′-Ihn′ to the PMOLED panel for achieving high-resolution images.

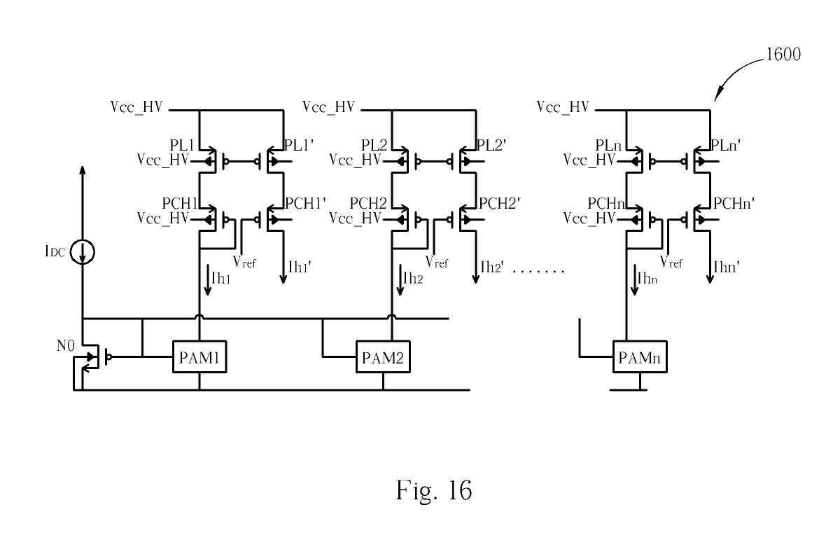

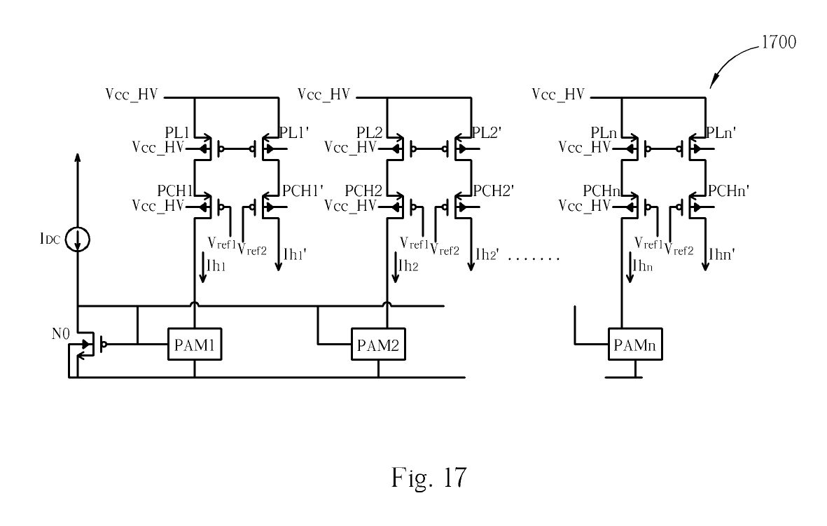

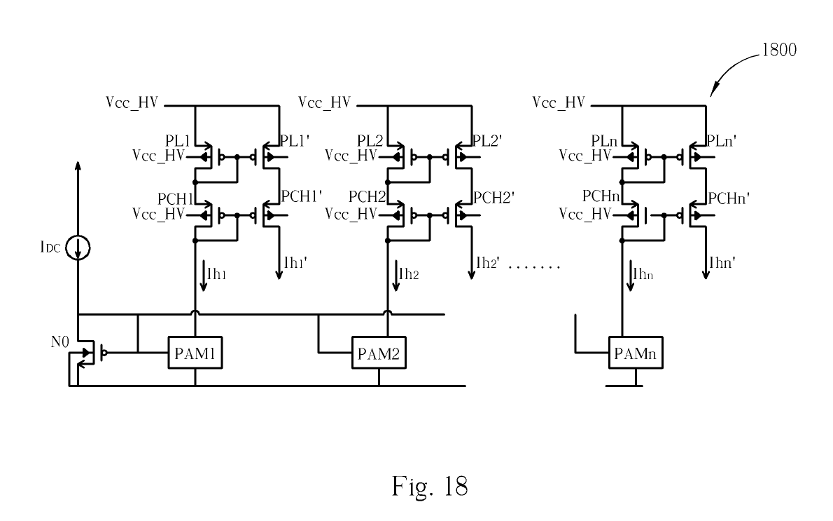

References are made to FIGS. 16-18 showing current mirrors 1600-1800 according to a sixth, seventh and eighth embodiments of the present invention based on the structure of the current mirror 1500. Similar to the current mirror 1500, the HV PMOS transistors PCH1-PCHn and PCH1′-PCHn′ are used for the HV devices in the current mirrors 1600-1800. However, the gate terminals of the HV PMOS transistors PCH1-PCHn and PCH1′-PCHn′ are coupled differently in the current mirrors 1600-1800. In the current mirror 1600 shown in FIG. 16, the gate terminals and drain terminals of the HV PMOS transistors PCH1-PCHn are coupled together, and the gate terminals of the HV PMOS transistors PCH1′-PCHn′ are coupled to a reference voltage Vref. In the current mirror 1700 shown in FIG. 17, the gate terminals of the HV PMOS transistor PCH1-PCHn are coupled to a first reference voltage Vref1, and the gate terminals of the HV PMOS transistors PCH1′-PCHn′ are coupled to a second reference voltage Vref2. In the current mirror 1800 shown in FIG. 18, the gate terminals and the drain terminals of the HV PMOS transistor PCH1-PCHn are coupled together. Various circuits commonly known to those skilled in the art can be used for generating the reference voltages Vref, Vref1, and Vref2.

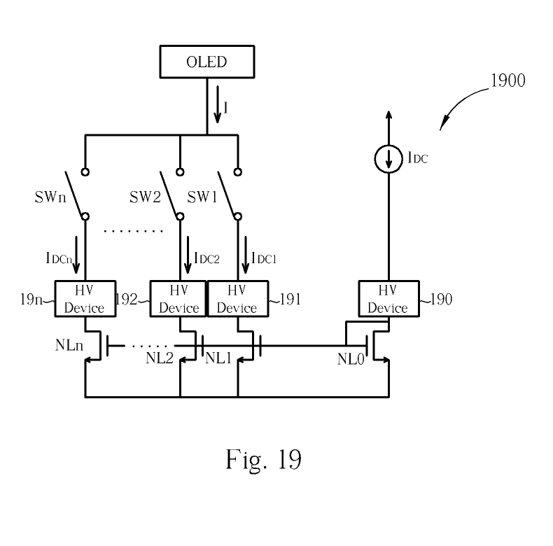

Reference is made to FIG. 19 showing a sink-mode current mirror 1900 for driving an AMOLED panel according to the present invention. The current mirror 1900 includes a current source I_{DC}, n+1 LV NMOS transistors NL0-NLn (only NL0, NL1, NL2 and NLn are depicted in FIG. 19), HV devices 190-19n (only 190, 191, 192 and 19n are depicted in FIG. 19), and switches SW1-SWn (only SW1, SW2 and SWn are depicted in FIG. 19). Unlike the prior art current mirror 700, the current mirror 1900 of the present invention includes the LV NMOS transistors NL0-NLn and the HV devices 190-19n for respectively biasing the LV NMOS transistors NL0-NLn. The HV devices 190-19n can include HV NMOS transistors. The drain terminal of the LV NMOS transistor NL0 is coupled to the current source I_{DC} via the HV device 190, and the drain terminals of the LV NMOS transistor NL1-NLn are coupled to the AMOLED panel via the HV device 191-19n and the switches SW1-SWn, respectively. The current mirror 1900 controls the amount of the driving current using the switches SW1-SWn. Since the threshold voltage of an LV NMOS transistor is more stable than that of a HV NMOS transistor, the currents passing through the LV NMOS transistors NL1-NLn do not have large variations. Therefore, the current mirror 1900 can provide stable driving currents to the AMOLED panel for achieving high-resolution images.

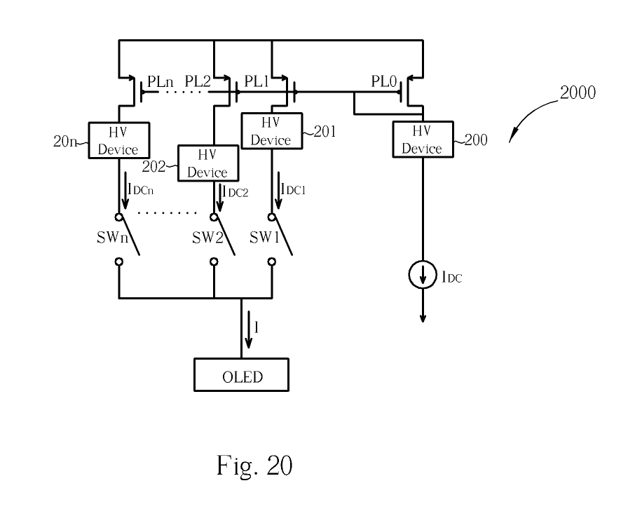

Reference is made to FIG. 20 showing a source-mode current mirror 2000 for driving an AMOLED panel according to the present invention. The current mirror 2000 includes a current source I_{DC}, n+1 LV PMOS transistors PL0-PLn (only PL0, PL1, PL2 and PLn are depicted in FIG. 20), HV devices 200-20n (only 200, 201, 202 and 20n are depicted in FIG. 20), and switches SW1-SWn (only SW1, SW2 and SWn are depicted in FIG. 20). Unlike the prior art current mirror 800, the current mirror 2000 of the present invention includes the LV PMOS transistors PL0-PLn and the HV devices 200-20n for respectively biasing the LV PMOS transistors PL0-PLn. The HV devices 200-20n can include HV PMOS transistors. The drain terminal of the LV PMOS transistor PL0 is coupled to the current source I_{DC} via the HV device 200, and the drain terminals of the LV PMOS transistor PL1-PLn are coupled to the AMOLED panel via the HV device 201-20n and the switches SW1-SWn, respectively. The current mirror 2000 controls the amount of the driving current using the switches SW1-SWn. Since the threshold voltage of an LV PMOS transistor is more stable than that of a HV PMOS transistor, the currents passing through the LV PMOS transistors PL1-PLn do not have large variations. Therefore, the current mirror 2000 can provide stable driving currents to the AMOLED panel for achieving high-resolution images.

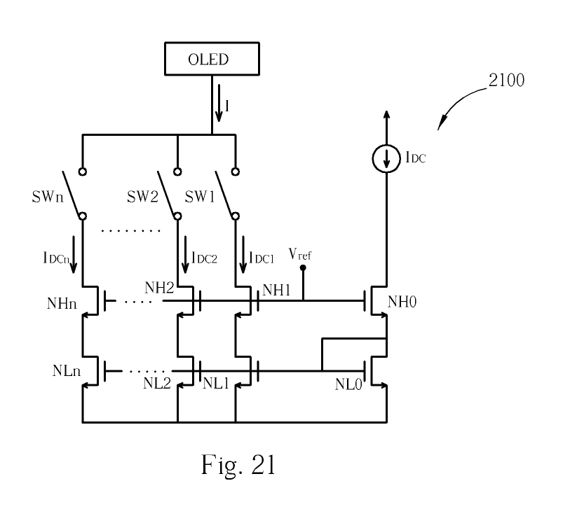

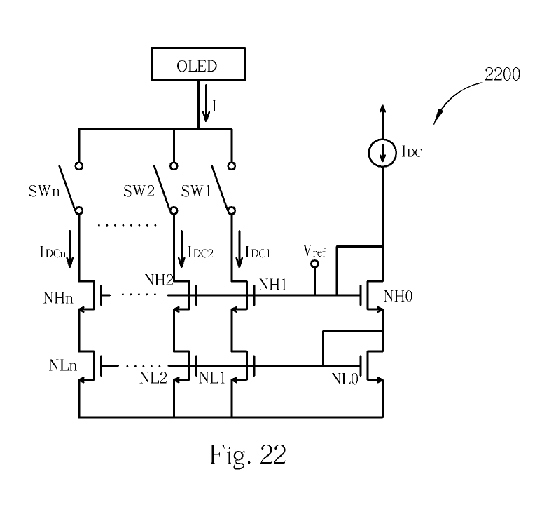

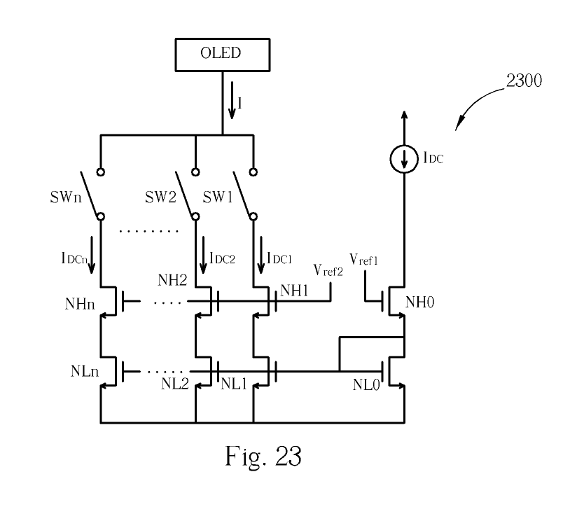

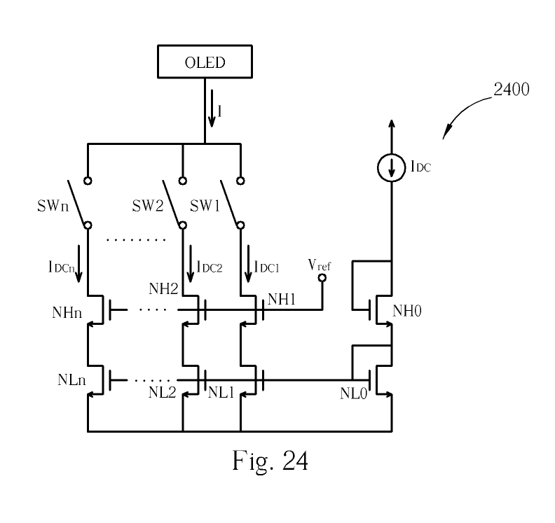

References are made to FIGS. 21-24 showing current mirrors 2100-2400 according to a ninth, tenth, eleventh and twelfth embodiments of the present invention based on the structure of the sink-mode current mirror 1900. Similar to the sink-mode current mirror 1900, the HV NMOS transistors NH0-NHn are used for the HV devices in the current mirrors 2100-2400. However, the gate terminals of the HV NMOS transistors NH1-NHn are coupled differently in the current mirrors 2100-2400. In the current mirror 2100 shown in FIG. 21, the gate terminals of the HV NMOS transistors NH0-NHn are coupled to a reference voltage Vref. In the current mirror 2200 shown in FIG. 22, the gate terminal and the source terminal of the HV NMOS transistor NH0 are coupled together. In the current mirror 2300 shown in FIG. 23, the gate terminal of the HV NMOS transistor NH0 is coupled to a first reference voltage Vref1, and the gate terminals of the HV NMOS transistors NH1-NHn are coupled to a second reference voltage Vref2. In the current mirror 2400 shown in FIG. 24, the gate terminal and the source terminal of the HV NMOS transistor NH0 are coupled together, and the gate terminals of the HV NMOS transistors NH1-NHn are coupled to a reference voltage Vref. Various circuits commonly known to those skilled in the art can be used for generating the reference voltages Vref, Vref1, and Vref2.

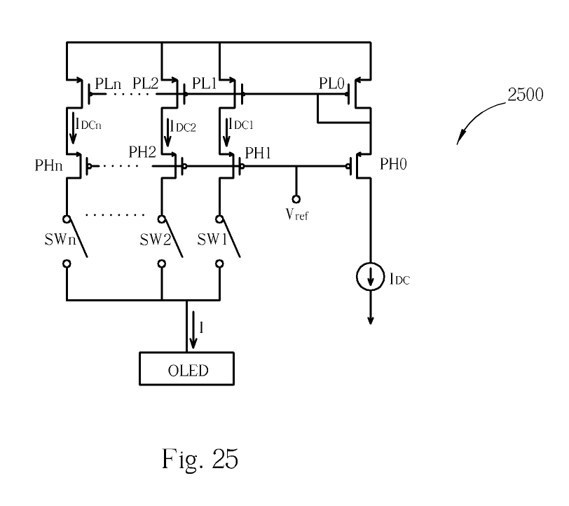

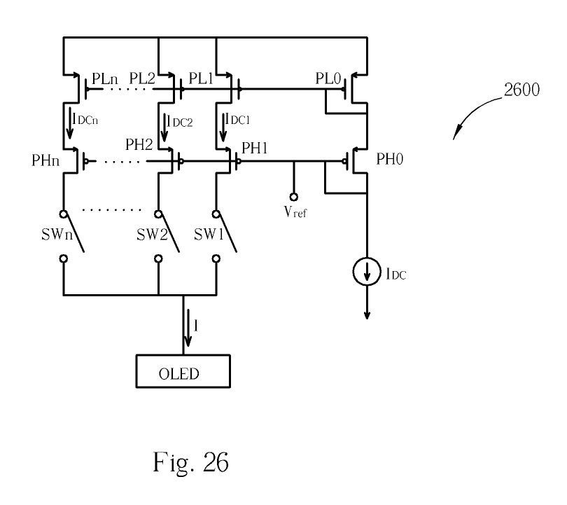

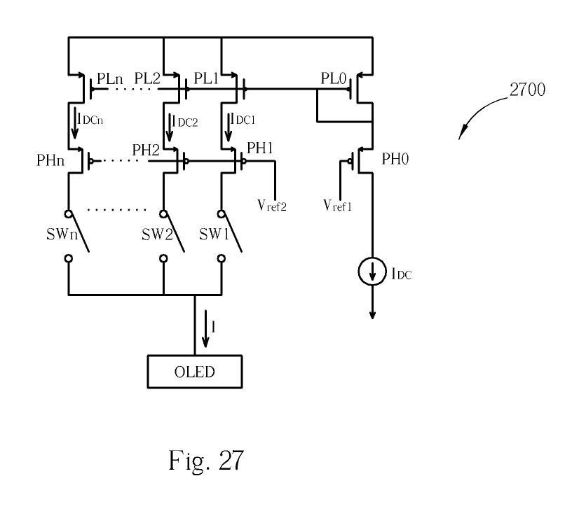

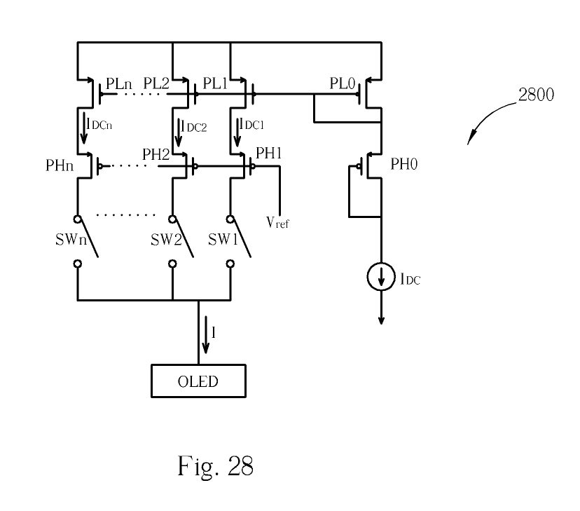

References are made to FIGS. 25-28 showing current mirrors 2500-2800 according to a thirteenth, fourteenth, fifteenth and sixteenth embodiments of the present invention based on the structure of the source-mode current mirror 2000. Similar to the source-mode current mirror 2000, the HV PMOS transistors PH1-PHn are used for the HV devices in the current mirrors 2500-2800. However, the gate terminals of the HV PMOS transistors PH1-PHn are coupled differently in the current mirrors 2500-2800. In the current mirror 2500 shown in FIG. 25, the gate terminals of the HV PMOS transistors PH0-PHn are coupled to a reference voltage Vref. In the current mirror 2600 shown in FIG. 26, the gate terminal and the source terminal of the HV PMOS transistor PH0 are coupled together. In the current mirror 2700 shown in FIG. 27, the gate terminal of the HV PMOS transistor PH0 is coupled to a first reference voltage Vref1, and the gate terminals of the HV PMOS transistors PH1-PHn are coupled to a second reference voltage Vref2. In the current mirror 2800 shown in FIG. 28, the gate terminal and the source terminal of the HV PMOS transistor PH0 are coupled together, and the gate terminals of the HV PMOS transistors PH1-PHn are coupled to a reference voltage Vref. Various circuits commonly known to those skilled in the art can be used for generating the reference voltages Vref, Vref1, and Vref2.

In conclusion, the present invention provides a current mirror using LV transistors in connection to HV devices providing biasing voltages. The current mirrors according to the present invention can receive a high voltage used for an OLED panel, and at the same time provide stable driving currents using LV transistors with stable threshold voltages, so that the OLED panel can provide high-resolution images. Diagrams illustrated in FIG. 9-FIG. 28 are merely embodiments of the present invention and do not limit the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current mirror for driving an organic light-emitting diode (OLED) panel comprising:
a first low voltage P-type metal oxide semiconductor (LV PMOS) transistor comprising:
a source terminal coupled to a first reference voltage;
a drain terminal; and
a gate terminal coupled to the drain terminal of the first LV PMOS transistor;
a second LV PMOS transistor comprising:
a source terminal coupled to the first reference voltage;
a drain terminal; and
a gate terminal coupled to the gate terminal of the first LV PMOS transistor;
a first high voltage (HV) device coupled between the drain terminal of the first LV PMOS transistor and a first current source for biasing the first LV PMOS transistor to operate at a predetermined low voltage; and
a second HV device coupled between the drain terminal of the second LV PMOS transistor and the OLED panel for biasing the second LV PMOS transistor to operate at the predetermined low voltage.

2. The current mirror of claim 1 wherein:
the first LV PMOS transistor further includes a base terminal coupled to the first reference voltage; and
the second LV PMOS transistor further includes a base terminal coupled to the first reference voltage.

3. The current mirror of claim 1 wherein:
the first HV device includes a first high voltage P-type metal oxide semiconductor (HV PMOS) transistor comprising:
a source terminal coupled to the drain terminal of the first LV PMOS transistor;
a drain terminal coupled to the first current source; and
a gate terminal coupled to a second reference voltage; and
the second HV device includes a second HV PMOS transistor comprising:
a source terminal coupled to the drain terminal of the second LV PMOS transistor;
a drain terminal coupled to the OLED panel; and
a gate terminal coupled to a third reference voltage.

4. The current mirror of claim 3 wherein the gate terminal of the first HV PMOS transistor is coupled to the drain terminal of the first HV PMOS transistor.

5. The current mirror of claim 3 wherein the second reference voltage is equal to the third reference voltage.

6. The current mirror of claim 5 wherein the gate terminal of the first HV PMOS transistor is coupled to the drain terminal of the first HV PMOS transistor, and the gate terminal of the second HV PMOS transistor is coupled to the drain terminal of the first HV PMOS transistor.

7. The current mirror of claim 1 further comprising:
a first number of LV PMOS transistors each including:
a source terminal coupled to the first reference voltage;
a drain terminal; and
a gate terminal coupled to the drain terminal of the first LV PMOS transistor; and
a first number of HV devices each coupled between the OLED panel and the drain terminal of a corresponding LV PMOS transistor among the first number of LV PMOS transistors for biasing the first number of LV PMOS transistors to operate at the predetermined low voltage.

8. The current mirror of claim 7 wherein each of the first number of LV PMOS transistors further includes a base terminal coupled to the first reference voltage.

9. The current mirror of claim 7 wherein:
the first HV device includes a first HV PMOS transistor comprising:
a source terminal coupled to the drain terminal of the first LV PMOS transistor;
a drain terminal coupled to the first current source; and
a gate terminal coupled to a second reference voltage; and
the second HV device includes a second HV PMOS transistor comprising:
a source terminal coupled to the drain terminal of the second LV PMOS transistor;
a drain terminal coupled to the OLED panel; and
a gate terminal coupled to a third reference voltage; and
the first number of HV devices each includes a HV PMOS transistor comprising:
a source terminal coupled to the drain terminal of a corresponding LV PMOS transistor;
a drain terminal coupled to the OLED panel; and
a gate terminal coupled to the third reference voltage.

10. The current mirror of claim 9 wherein the second reference voltage is equal to the third reference voltage.

11. The current mirror of claim 10 wherein the gate terminal of each HV PMOS transistor is coupled to the drain terminal of the first HV PMOS.

12. The current mirror of claim 9 wherein the gate terminal of the first HV PMOS transistor is coupled to the drain terminal of the first HV PMOS.

13. The current mirror of claim 1 being a current mirror for driving a passive matrix organic light-emitting diode (PMOLED) panel.

14. The current mirror of claim 1 being a current mirror for driving a current-mode active matrix organic light-emitting diode (AMOLED) panel.

15. An OLED display comprising:
an OLED panel; and
a current mirror for driving the OLED panel, the current mirror comprising:
a first LV PMOS transistor comprising:
a source terminal coupled to a first reference voltage;
a drain terminal; and
a gate terminal coupled to the drain terminal of the first LV PMOS transistor;
a second LV PMOS transistor comprising:
a source terminal coupled to the first reference voltage;
a drain terminal; and
a gate terminal coupled to the gate terminal of the first LV PMOS transistor;
a first HV device coupled between the drain terminal of the first LV PMOS transistor and a first current source for biasing the first LV PMOS transistor to operate at a predetermine low voltage; and
a second HV device coupled between the drain terminal of the second LV PMOS transistor and the OLED panel for biasing the second LV PMOS transistor to operate at the predetermined low voltage.

16. The OLED display of claim 15 wherein:
the first LV PMOS transistor further includes a base terminal coupled to the first reference voltage; and
the second LV PMOS transistor further includes a base terminal coupled to the first reference voltage.

17. The OLED display of claim 15 wherein:
the first HV device includes a first HV PMOS transistor comprising:
a source terminal coupled to the drain terminal of the first LV PMOS transistor;
a drain terminal coupled to the first current source; and
a gate terminal coupled to a second reference voltage source; and
the second HV device includes a second HV PMOS transistor comprising:
a source terminal coupled to the drain terminal of the second LV PMOS transistor;
a drain terminal coupled to the OLED panel; and
a gate terminal coupled to a third reference voltage.

18. The OLED display of claim 17 wherein the second reference voltage is equal to the third reference voltage.

19. The OLED display of claim 18 wherein the gate terminal of the first HV PMOS transistor is coupled to the drain terminal of the first HV PMOS transistor, and the gate terminal of the second HV PMOS transistor is coupled to the drain terminal of the first HV PMOS transistor.

20. The OLED display of claim 17 wherein the gate terminal of the first HV PMOS transistor is coupled to the drain terminal of the first HV PMOS transistor.

21. The OLED display of claim 15 wherein the current mirror further comprises:
a first number of LV PMOS transistors each including:
a source terminal coupled to the first reference voltage;
a drain terminal; and
a gate terminal coupled to the gate terminal of the first LV PMOS transistor; and
a first number of HV devices each coupled between the OLED panel and the drain of a corresponding LV PMOS transistor among the first number of LV PMOS transistors for biasing the first number of LV PMOS transistors.

22. The OLED display of claim 21 wherein each of the first number of LV PMOS transistors further includes a base terminal coupled to the first reference.

23. The OLED display of claim 21 wherein:
the first HV device includes a first HV PMOS transistor comprising:
a source terminal coupled to the drain terminal of the first LV PMOS transistor;
a drain terminal coupled to the first current source; and
a gate terminal coupled to a second reference voltage source; and
the second HV device includes a second HV PMOS transistor comprising:
a source terminal coupled to the drain terminal of the second LV PMOS transistor;
a drain terminal coupled to the OLED panel; and
a gate terminal coupled to a third reference voltage; and
the first number of HV devices each includes a HV PMOS transistor comprising:
a source terminal coupled to the drain terminal of a corresponding LV PMOS transistor;
a drain terminal coupled to the OLED panel; and
a gate terminal coupled to the third reference voltage.

24. The OLED display of claim 23 wherein the second reference voltage is equal to the third reference voltage.

25. The OLED display of claim 24 wherein the gate terminal of each HV PMOS transistor is coupled to the drain terminal of the first HV PMOS.

26. The OLED display of claim 23 wherein the gate terminal of the first HV PMOS transistor is coupled to the drain terminal of the first HV PMOS.

27. The OLED display of claim 15 wherein the OLED panel is a PMOLED panel.

28. The OLED display of claim 15 wherein the OLED panel is a current-mode AMOLED panel.

29. A current mirror for driving a PMOLED panel comprising:
a current source;
a first LV PMOS transistor comprising:
a source terminal coupled to a first reference voltage;
a drain terminal; and
a gate terminal coupled to the drain terminal of the first LV PMOS transistor;
a second LV PMOS transistor comprising:
a source terminal coupled to the first reference voltage;
a drain terminal; and
a gate terminal coupled to the drain terminal of the first LV PMOS transistor;
a first HV device coupled to the drain terminal of the first LV PMOS transistor for biasing the first LV PMOS transistor to operate at a predetermine low voltage;
a second HV device coupled to the drain terminal of the second LV PMOS transistor and the PMOLED panel for biasing the second LV PMOS transistor to operate at the predetermined low voltage;
a pulse amplitude modulation (PAM) module coupled to the first HV device for controlling the current passing through the first LV PMOS transistor; and
an N-type metal oxide semiconductor (NMOS) transistor comprising:
a source terminal coupled to the current source;
a drain terminal; and
a gate coupled to the PAM module for enabling the PAM module.

30. The current mirror of claim 29 wherein:
the first and second LV PMOS transistors each further include a base terminal coupled to the first reference voltage.

31. The current mirror of claim 29 wherein:
the first HV device includes a first HV PMOS transistor comprising:
a source terminal coupled to the drain terminal of the first LV PMOS transistor;
a drain terminal coupled to the PAM module; and
a gate terminal coupled to a second reference voltage; and
the second HV device includes a second HV PMOS transistor comprising:
a source terminal coupled to the drain terminal of the second LV PMOS transistor;
a drain terminal coupled to the OLED panel; and
a gate terminal coupled to a third reference voltage.

32. The current mirror of claim 31 wherein the gate terminal of the first HV PMOS transistor is coupled to the drain terminal of the first HV PMOS transistor.

33. The current mirror of claim 31 wherein the second reference voltage is equal to the third reference voltage.

34. The current mirror of claim 33 wherein the gate terminal of the first HV PMOS transistor is coupled to the drain terminal of the first HV PMOS transistor.

35. The current mirror of claim 29 wherein the NMOS transistor is a HV NMOS transistor.

36. The current mirror of claim 29 wherein the PAM module comprises:
a plurality of NMOS transistors coupled in parallel; and
a plurality of switches each coupled in series with a corresponding NMOS transistor among the plurality of NMOS transistors.

37. The current mirror of claim 29 further comprising:
a first number of first LV PMOS transistors each including:
a source terminal coupled to the first reference voltage;
a drain terminal; and
a gate terminal coupled to the drain terminal of the first LV PMOS transistor; and
a first number of second LV PMOS transistors each including:
a source terminal coupled to the first reference voltage;
a drain terminal; and
a gate terminal coupled to the drain terminal of a corresponding first LV PMOS transistor among the first number of first LV PMOS transistors; and
a first number of first HV devices each coupled to the drain terminal of a corresponding first LV PMOS transistor among the first number of first LV PMOS transistors for biasing the first number of first LV PMOS transistors to operate at the predetermined low voltage;
a first number of second HV devices each coupled between the OLED panel and the drain terminal of a corresponding second LV PMOS transistor among the first number of second LV PMOS transistors for biasing the first number of second LV PMOS transistors to operate at the predetermined low voltage; and
a first number of PAM modules each coupled between a corresponding first HV device among the first number of first HV devices and the drain terminal of the NMOS transistor for controlling the current passing through the corresponding first LV PMOS transistor among the first number of first LV PMOS transistors.

38. The current mirror of claim 37 wherein:
the first number of first LV PMOS transistors each further includes a base terminal coupled to the first reference voltage; and
the first number of the second LV PMOS transistors each further includes a base terminal coupled to the first reference voltage.

39. The current mirror of claim 37 wherein:
the first number of first HV devices each include a first HV PMOS transistor comprising:
a source terminal coupled to the drain terminal of a corresponding first LV PMOS transistor among the first number of first LV PMOS transistors;
a drain terminal coupled to a corresponding PAM module among the first number of PAM modules; and
a gate coupled to a second reference voltage source; and
the first number of second HV devices includes a second HV PMOS transistor comprising:
a source terminal coupled to the drain terminal of a corresponding second LV PMOS transistor among the first number of second LV PMOS transistors;
a drain terminal coupled to the OLED panel; and
a gate terminal coupled to a third reference voltage.

40. The current mirror of claim 39 wherein the gate terminal of each of the first number of first HV PMOS transistor is coupled to the drain terminal of the first HV PMOS transistor.

41. The current mirror of claim 37 wherein the first number of PAM modules each includes:
a plurality of NMOS transistors coupled in parallel: and
a plurality of switches each coupled in series with a corresponding NMOS transistor of the plurality of NMOS transistors.

42. A PMOLED display comprising:
a PMOLED panel; and
a current source for driving the PMOLED panel comprising;
a first LV PMOS transistor comprising:
a source terminal coupled to a first reference voltage;
a drain terminal; and
a gate terminal coupled to the drain terminal of the first LV PMOS transistor;
a second LV PMOS transistor comprising:
a source terminal coupled to the first reference voltage;
a drain terminal; and
a gate terminal coupled to the drain terminal of the first LV PMOS transistor;
a first HV device coupled to the drain terminal of the first LV PMOS transistor for biasing the first LV PMOS transistor to operate at a predetermined low voltage;
a second HV device coupled between the drain terminal of the second LV PMOS transistor and the PMOLED panel for biasing the second LV PMOS transistor to operate at the predetermined low voltage;
a PAM module coupled to the first HV device for controlling the current passing through the first LV PMOS transistor; and
an NMOS transistor comprising:
a source terminal coupled to the current source;
a drain terminal; and
a gate terminal coupled to the PAM module for enabling the PAM module.

43. The PMOLED display of claim 42 wherein:
the first and second LV PMOS transistors each further include a base terminal coupled to the first reference voltage.

44. The PMOLED display of claim 42 wherein:
the first HV device includes a first HV PMOS transistor comprising:
a source terminal coupled to the drain terminal of the first LV PMOS transistor;
a drain terminal coupled to the PAM module; and
a gate terminal coupled to a second reference voltage; and
the second HV device includes a second HV PMOS transistor comprising:
a source terminal coupled to the drain terminal of the second LV PMOS transistor;
a drain terminal coupled to the PMOLED panel; and
a gate terminal coupled to a third reference voltage source.

45. The PMOLED display of claim 44 wherein the gate terminal of the first HV PMOS transistor is coupled to the drain terminal of the first HV PMOS transistor.

46. The PMOLED display of claim 44 wherein the second reference voltage is equal to the third reference voltage.

47. The PMOLED display of claim 46 wherein the gate terminal of the first HV PMOS transistor is coupled to the drain terminal of the first HV PMOS transistor.

48. The PMOLED display of claim 42 wherein the PAM module comprises:
a plurality of NMOS transistors coupled in parallel: and
a plurality of switches each coupled in series with a corresponding NMOS transistor among the plurality of NMOS transistors.

49. The PMOLED display of claim 42 further comprising:
a first number of first LV PMOS transistors each including:
a source terminal coupled to the first reference voltage;
a drain terminal; and
a gate terminal coupled to the drain terminal of the first LV PMOS transistor; and
a first number of second LV PMOS transistors each including:
a source terminal coupled to the first reference voltage;
a drain terminal; and
a gate coupled to the drain terminal of a corresponding second LV PMOS transistor among the first number of second LV PMOS transistors; and
a first number of first HV devices each coupled to the drain terminal of a corresponding first LV PMOS transistor among the first number of first LV PMOS transistors for biasing the first number of first LV PMOS transistors to operate at the predetermined low voltage;
a first number of second HV devices each coupled between the PMOLED panel and the drain terminal of a corresponding second LV PMOS transistor among the first number of second LV PMOS transistors for biasing the first number of second LV PMOS transistors to operate at the predetermined voltage; and
a first number of PAM modules each coupled to a corresponding first HV device among the first number of first HV devices and the drain terminal of the NMOS transistor.

50. The PMOLED display of claim 49 wherein:
the first number of first LV PMOS transistors each further includes a base terminal coupled to the first reference voltage; and
the first number of the second LV PMOS transistors each further includes a base terminal coupled to the first reference voltage source.

51. The PMOLED display of claim 49 wherein:
the first number of first HV devices each include a first HV PMOS transistor comprising:
a source terminal coupled to the drain terminal of a corresponding first LV PMOS transistor among the first number of first LV PMOS transistors;
a drain terminal coupled to a corresponding PAM module among the first number of PAM modules; and
a gate terminal coupled to a second reference voltage source; and
the first number of second HV devices includes a second HV PMOS transistor comprising:
a source terminal coupled to the drain terminal of a corresponding second LV PMOS transistor among the first number of second LV PMOS transistors;
a drain terminal coupled to the PMOLED panel; and
a gate terminal coupled to a third reference voltage source.

52. The PMOLED display of claim 49 wherein the gate of each of the first number of first HV PMOS transistor is coupled to the drain terminal of the first HV PMOS transistor.

53. The PMOLED display of claim 42 wherein the first number of PAM modules each includes:
a plurality of NMOS transistors coupled in parallel; and
a plurality of switches each coupled in series with a corresponding NMOS transistor among the plurality of NMOS transistors.

54. A current mirror for driving an AMOLED panel comprising:
a current source;
a first LVNMOS transistor comprising:
a source terminal;
a drain terminal; and
a gate terminal coupled to the drain terminal of the first LVNMOS transistor;
a second LVNMOS transistor comprising:
a source terminal coupled to the source terminal of the first LVNMOS transistor;
a drain terminal; and
a gate terminal coupled to the gate terminal of the first LVNMOS transistor;
a first HV device coupled between the drain terminal of the first LVNMOS transistor and the current source for biasing the first LVNMOS transistor to operate at a predetermined low voltage;
a second HV device coupled to the drain terminal of the second LVNMOS transistor for biasing the second LVNMOS transistor to operate at the predetermined low voltage; and
a switch coupled between the second HV device and the AMOLED panel.

55. The current mirror of claim 54 wherein the source terminal of the first LVNMOS transistor is coupled to ground.

56. The current mirror of claim 54 wherein:
the first HV device includes a first HV NMOS transistor comprising:
a source terminal coupled to the drain terminal of the first LVNMOS transistor;
a drain terminal coupled to the current source; and
a gate terminal coupled to a first reference voltage source; and
the second HV device includes a second HV NMOS transistor comprising:
a source terminal coupled to the drain terminal of the second LVNMOS transistor;
a drain terminal coupled to the switch; and
a gate terminal coupled to a second reference voltage source.

57. The current mirror of claim 56 wherein the gate terminal of the first HV NMOS transistor is coupled to the drain terminal of the first HV NMOS transistor.

58. The current mirror of claim 56 wherein the first reference voltage is equal to the second reference voltage.

59. The current mirror of claim 58 wherein the gate terminal of the first HV NMOS transistor is coupled to the drain terminal of the first HV NMOS transistor.

60. The current mirror of claim 54 further comprising:
a first number of third LVNMOS transistors each including:
a source terminal coupled to the source terminal of the first LVNMOS transistor;
a drain terminal; and
a gate terminal coupled to the gate terminal of the first LVNMOS transistor;
a first number of third HV devices each coupled to the drain terminal of a corresponding third LVNMOS transistor among the first number of third LVNMOS transistors for biasing the first number of third LVNMOS transistors to operate at the predetermined low voltage; and
a first number of switches each coupled between a corresponding third HV device and the AMOLED panel.

61. The current mirror of claim 60 wherein the first number of third HV devices each include a third HV NMOS transistor comprising:
a source terminal coupled to the drain terminal of a corresponding third LVNMOS transistor among the first number of third LVNMOS transistors;
a drain terminal coupled to a corresponding switch among the first number of switches; and
a gate terminal coupled to the second reference voltage source.

62. An AMOLED display comprising:
an AMOLED panel; and
a current source for driving the AMOLED panel including:
a first LVNMOS transistor comprising:
a source terminal;
a drain terminal; and
a gate terminal coupled to the drain terminal of the first LVNMOS transistor;
a second LVNMOS transistor comprising:
a source terminal coupled to the source terminal of the first LVNMOS transistor;
a drain terminal; and
a gate terminal coupled to the gate terminal of the first LVNMOS transistor;
a first HV device coupled between the drain terminal of the first LVNMOS transistor and the current source for biasing the first LVNMOS transistor to operate at a predetermined low voltage;
a second HV device coupled to the drain terminal of the second LVNMOS transistor for biasing the second LVNMOS transistor to operate at the predetermined low voltage; and
a switch coupled between the second HV device and the AMOLED panel.

63. The AMOLED display of claim 62 wherein the source terminal of the first LVNMOS transistor is coupled to ground.

64. The AMOLED display of claim 62 wherein:
the first HV device includes a first HV NMOS transistor comprising:
a source terminal coupled to the drain terminal of the first LVNMOS transistor;
a drain terminal coupled to the current source; and
a gate terminal coupled to a first reference voltage source; and
the second HV device includes a second HV NMOS transistor comprising:
a source terminal coupled to the drain terminal of the second LVNMOS transistor;
a drain terminal coupled to the switch; and
a gate terminal coupled to a second reference voltage source.

65. The AMOLED display of claim 62 wherein the gate terminal of the first HV NMOS transistor is coupled to the drain terminal of the first HV NMOS transistor.

66. The AMOLED display of claim 62 wherein the first reference voltage is equal to the second reference voltage.

67. The AMOLED display of claim 66 wherein the gate terminal of the first HV NMOS transistor is coupled to the drain terminal of the first HV NMOS transistor.

68. The AMOLED display of claim 62 further comprising:
a first number of third LVNMOS transistors each including:
a source terminal coupled to the source terminal of the first LVNMOS transistor;
a drain terminal; and
a gate terminal coupled to the gate terminal of the first LVNMOS transistor;
a first number of third HV devices each coupled to the drain terminal of a corresponding third LVNMOS transistor among the first number of third LVNMOS transistors for biasing the first number of third LVNMOS transistors to operate at the predetermined low voltage; and
a first number of switches each coupled between a corresponding third HV device among the first number of third HV devices and the AMOLED panel.

69. The AMOLED display of claim 68 wherein the first number of third HV devices each include a third HV NMOS transistor comprising:
a source terminal coupled to the drain terminal of a corresponding third LVNMOS transistor among the first number of third LVNMOS transistors;
a drain terminal coupled to a corresponding switch among the first number of switches; and
a gate terminal coupled to the second reference voltage source.

70. A current mirror for driving an AMOLED panel comprising:
a current source;
a first LV PMOS transistor comprising:
a source terminal;
a drain terminal; and
a gate terminal coupled to the drain terminal of the first LV PMOS transistor;
a second LV PMOS transistor comprising:
a source terminal coupled to the source terminal of the first LV PMOS transistor;
a drain terminal; and
a gate terminal coupled to the gate terminal of the first LV PMOS transistor;
a first HV device coupled between the drain terminal of the first LVPMOS transistor and the current source for biasing the first LV PMOS transistor to operate at a predetermined low voltage;
a second HV device coupled to the drain terminal of the second LVPMOS transistor for biasing the second LV PMOS transistor to operate at the predetermined low voltage; and
a switch coupled between the second HV device and the AMOLED panel.

71. The current mirror of claim 70 wherein:
the first HV device includes a first HV PMOS transistor comprising:
a source terminal coupled to the drain terminal of the first LV PMOS transistor;
a drain terminal coupled to the current source; and
a gate terminal coupled to a first reference voltage source; and
the second HV device includes a second HV PMOS transistor comprising:
a source terminal coupled to the drain terminal of the second LV PMOS transistor;
a drain terminal coupled to the switch; and
a gate terminal coupled to a second reference voltage source.

72. The current mirror of claim 71 wherein the gate terminal of the first HV PMOS transistor is coupled to the drain terminal of the first HV PMOS transistor.

73. The current mirror of claim 71 wherein the first reference voltage is equal to the second reference voltage.

74. The current mirror of claim 73 wherein the gate terminal of the first HV PMOS transistor is coupled to the drain terminal of the first HV PMOS transistor.

75. The current mirror of claim 71 further comprising:
a first number of third LV PMOS transistors each including:
a source terminal coupled to the source terminal of the first LV PMOS transistor;
a drain terminal; and
a gate terminal coupled to the gate terminal of the first LV PMOS transistor;
a first number of third HV devices each coupled to the drain terminal of a corresponding third LV PMOS transistor among the first number of third LV PMOS transistors for biasing the first number of third LV PMOS transistors to operate at the predetermined low voltage; and
a first number of switches each coupled between a corresponding third HV device and the AMOLED panel.

76. The current mirror of claim 75 wherein the first number of third HV devices each include a third HV PMOS transistor comprising:
a source terminal coupled to the drain terminal of a corresponding third LV PMOS transistor among the first number of third LV PMOS transistors;
a drain terminal coupled to a corresponding switch among the first number of switches; and
a gate terminal coupled to the second reference voltage.

77. An AMOLED display comprising:
an AMOLED panel; and
a current source for driving the AMOLED panel including:
a first LV PMOS transistor comprising:
a source terminal;
a drain terminal; and
a gate terminal coupled to the drain terminal of the first LV PMOS transistor;
a second LV PMOS transistor comprising:
a source terminal coupled to the source terminal of the first LV PMOS transistor;
a drain terminal; and
a gate terminal coupled to the gate terminal of the first LV PMOS transistor;
a first HV device coupled between the drain terminal of the first LV PMOS transistor and the current source for biasing the first LV PMOS transistor to operate at a predetermined low voltage;
a second HV device coupled to the drain terminal of the second LV PMOS transistor for biasing the second LV PMOS transistor to operate at the predetermined low voltage; and
a switch coupled between the second HV device and the AMOLED panel.

78. The AMOLED display of claim 77 wherein:
the first HV device includes a first HV PMOS transistor comprising:
a source terminal coupled to the drain terminal of the first LV PMOS transistor;
a drain terminal coupled to the current source; and
a gate terminal coupled to a first reference voltage source; and
the second HV device includes a second HV PMOS transistor comprising:
a source terminal coupled to the drain terminal of the second LV PMOS transistor;
a drain terminal coupled to the switch; and
a gate terminal coupled to a second reference voltage source.

79. The AMOLED display of claim 78 wherein the gate terminal of the first HV PMOS transistor is coupled to the drain terminal of the first HV PMOS transistor.

80. The AMOLED display device of claim 78 wherein the first reference voltage is equal to the second reference voltage.

81. The display device of claim 80 wherein the gate terminal of the first HV PMOS transistor is coupled to the drain terminal of the first HV PMOS transistor.

82. The AMOLED display of claim 78 further comprising:
a first number of third LV PMOS transistors each including:
a source terminal coupled to the source terminal of the first LV PMOS transistor;
a drain terminal; and
a gate terminal coupled to the gate terminal of the first LV PMOS transistor;
a first number of third HV devices each coupled to the drain terminal of a corresponding third LV PMOS transistor among the first number of third LV PMOS transistors for biasing the first number of third LV PMOS transistors to operate at the predetermined low voltage; and
a first number of switches each coupled between a corresponding third HV device and the AMOLED panel.

83. The AMOLED display of claim 82 wherein the first number of third HV devices each includes a third HV PMOS transistor comprising:
a source terminal coupled to the drain terminal of a corresponding third LV PMOS transistor among the first number of third LV PMOS transistors;
a drain terminal coupled to a corresponding switch among the first number of switches; and
a gate terminal coupled to the second reference voltage source.
